(19) United States
(12) Patent Application Publication
(10) Pub. No.: US 2018/0287178 A1
(43) Pub. Date: Oct. 4, 2018

(54) CO-CASTING PROCESS FOR SOLID OXIDE REACTOR FABRICATION

(71) Applicant: Phillips 66 Company, Houston, TX (US)

(72) Inventors: Mingfei Liu, Bartlesville, OK (US); Ying Liu, Bartlesville, OK (US)

(73) Assignee: Phillips 66 Company, Houston, TX (US)

(21) Appl. No.: 15/935,460

(22) Filed: Mar. 26, 2018

Related U.S. Application Data
(60) Provisional application No. 62/477,775, filed on Mar. 28, 2017.

(51) Int. Cl. H01M 8/1226; H01M 8/1253; H01M 8/126; H01M 4/88

(52) U.S. Cl. CPC H01M 8/1226; H01M 8/1253; H01M 2008/1293; H01M 4/8857; H01M 4/8803; H01M 8/126

(57) ABSTRACT

A process for producing a solid oxide reactor. The process begins by separately preparing an anode slurry and an electrolyte slurry. The electrolyte slurry is then tape casted onto a support layer to produce an electrolyte layer situated above the support layer. The anode slurry is then tape casted onto the electrolyte layer to produce a first multilayer structure comprising an anode layer situated above the electrolyte layer situated above the support layer. The support layer is then removed from the first multilayer structure to produce a second multilayer structure comprising the anode layer situated above the electrolyte layer. The second multilayer structure is then sintered to produce a solid oxide reactor.

### CROSS-REFERENCE TO RELATED APPLICATIONS

This application is a non-provisional application which claims the benefit of and priority to U.S. Provisional Application Ser. No. 62/477,775 filed Mar. 28, 2017, entitled “Co-Casting Process for Solid Oxide Reactor Fabrication,” which is hereby incorporated by reference in its entirety.

### STATEMENT REGARDING FEDERALLY SPONSORED RESEARCH OR DEVELOPMENT

None.

### FIELD OF THE INVENTION

A process for producing solid oxide reactors.

### BACKGROUND OF THE INVENTION

A major challenge in fabricating high-performing solid oxide fuel cells is the quality (thickness, density, and uniformity) of thin electrolyte film on the anode support. There are many different methods of forming a dense-structure coating film on the surface of a support such as gas-phase methods and liquid-phase methods.

Examples of gas-phase methods may include electrochemical vapor deposition, chemical vapor deposition, sputtering, ion beam method, electron beam method, and the like. However, each of the gas-phase methods has at least one disadvantage, such as requirement of expensive manufacturing equipment, starting material restrictions, difficulty in fabricating a thick specimen attributable to low thin film growth rate, insufficient adhesion between a coating film and a substrate, stripping of a coating film due to residual stress, limitation in size of a specimen, and the like.

For this reason, liquid-phase methods, which are relatively easily carried out compared to gas-phase methods, are frequently used. Particularly, examples of liquid-phase methods may include sol-gel process, slip coating, slurry coating, spin coating, dip coating, electrochemical process, electrophoresis, hydrothermal synthesis, and the like. Among these liquid-phase methods, in the dip coating, spin coating, slurry coating including spray coating or sol-gel process, a coating layer is dried or gelled in the early stage because of its low green density, and simultaneously, is greatly contracted. The contraction of a coating layer causes a stress between a support and a coating layer, and this stress becomes more severe in the subsequent sintering process, thereby causing cracking of the coating layer and stripping of the coating layer from the support.

Others have attempted to form solid oxide cells such as United States Patent Publication 2014/0227613 and United States Patent Publication 2008/0124602. However, both of these methods are inefficient in producing solid oxide cells as they require methods such as individually tape casting layers on supports, lamination steps and the need to apply vacuum, pressure and temperature to achieve bonding.

There exists a need for an efficient process of producing solid oxide reactors that eliminates the cracking in the layers.

### BRIEF SUMMARY OF THE DISCLOSURE

A process for producing a solid oxide reactor. The process begins by separately preparing an anode slurry and an electrolyte slurry. The electrolyte slurry is then tape casted onto a support layer to produce an electrolyte layer situated above the support layer. The anode slurry is then tape casted onto the electrolyte layer to produce a first multilayer structure comprising an anode layer situated above the electrolyte layer situated above the support layer. The support layer is then removed from the first multilayer structure to produce a second multilayer structure comprising the anode layer situated above the electrolyte layer. The second multilayer structure is then sintered to produce a solid oxide reactor.

A process for producing a solid oxide fuel cell. The process begins by separately preparing an anode slurry and an electrolyte slurry. The electrolyte slurry is then tape casted onto a support layer to produce an electrolyte layer situated above the support layer. The anode slurry is then tape casted onto the electrolyte layer to produce a first multilayer structure comprising an anode layer situated above the electrolyte layer situated above the support layer. The support layer is then removed from the first multilayer structure to produce a second multilayer structure without cracks comprising the anode layer situated above the electrolyte layer. The second multilayer structure is then sintered to produce a solid oxide fuel cell without a lamination step.

### BRIEF DESCRIPTION OF THE DRAWINGS

A more complete understanding of the present invention and benefits thereof may be acquired by referring to the follow description taken in conjunction with the accompanying drawings in which:

FIG. 1 depicts a top down view of a multilayer structure.

FIG. 2 depicts a top down view of the electron microscope scan multilayer structure.

### DETAILED DESCRIPTION

Turning now to the detailed description of the preferred arrangement or arrangements of the present invention, it should be understood that the inventive features and concepts may be manifested in other arrangements and that the scope of the invention is not limited to the embodiments described or illustrated. The scope of the invention is intended only to be limited by the scope of the claims that follow.

The novel process begins by separately preparing an anode slurry and an electrolyte slurry. The electrolyte slurry can then be tape casted onto a support layer to produce an electrolyte layer situated above the support layer. The anode slurry can then be tape casted onto the electrolyte layer to produce a first multilayer structure comprising an anode layer situated above the electrolyte layer situated above the support layer. The support layer can then be removed from the first multilayer structure to produce a second multilayer structure comprising the anode layer situated above the electrolyte layer. In one embodiment, the second multilayer structure is then sintered to produce a solid oxide reactor.

This novel process produces solid oxide reactor that can then be made into solid oxide fuel cells, solid oxide electrolysis cells, direct carbon fuel cells, ion transport membranes, or other types of solid oxide reactors. The solid oxide reactor form may or may not be reversible based upon the number of layers applied to the support layer.

Formation of the anode slurry can be made by mixing suitable materials for forming the anodes with solvents, dispersants, binders and plasticizers to form stable slurries. Suitable materials for the formation of anodes can be compositions comprising NiO alone or mixed with Al₂O₃, TiO₂, Cr₂O₃, MgO or mixtures thereof and/or doped zirconia (such as yttria-stabilized zirconia) or doped ceria, and/or a metal oxide with an oxygen ion or proton conductivity. Suitable dopants are Sc, Y, Ce, Ga, Sm, Gd, Ca and/or any Ln element, or combinations thereof.

In other embodiments anodes can further comprising a catalyst (e.g. Ni and/or Cu) or precursor thereof mixed with doped zirconia, doped ceria and/or a metal oxide with an oxygen ion or proton conductivity. Other suitable materials for anode layers are materials selected from the group of Ni, Ni—Fe alloy, Cu, doped ceria, doped zirconia, or mixtures thereof. Alternatively, MaₛTi₁₋ₓMbₓO_{3-δ}, Ma=Ba, Sr, Ca; Mb=V, Nb, Ta, Mo, W, Th, U; 0≤s≤0.5; or LnCr₁₋ₓMₓO_{3-δ}, M=T, V, Mn, Nb, Mo, W, Th, U may be used as anode materials. X is preferably from about 0 to 1, more preferably from about 0.1 to 0.5, and most preferably from 0.2 to 0.3.

Formation of the electrolyte slurry can be made by mixing suitable materials for forming the electrolytes with solvents, dispersants, binders and plasticizers to form stable slurries. Suitable materials for the formation of the electrolytes include doped zirconia (such as yttria-stabilized zirconia), doped ceria, gallates or proton conducting electrolytes (SrCe(Yb)O_{3-δ}, BaZr(Y)O_{3-δ}), Ba(Ce, Zr)(M) (M=Y, Sc, La, Sm, Gd, Nd, Pr, Yb, Cu, Ni, Zn) or the like.

Formation of the cathode slurry can be made by mixing suitable materials for forming the cathodes with solvents, dispersants, binders and plasticizers to form stable slurries. Suitable materials for formation of the cathodes include LSM (La₁₋ₓSrₓ)MnO_{3-δ}), (Ln₁₋ₓSrₓ)MnO_{3-δ}, LSFC (La₁₋ₓSrₓ)Fe_{1-y}Co_{y}O_{3-δ}, (Ln₁₋ₓSrₓ)Fe_{1-y}Co_{y}O_{3-δ}, (Y₁₋ₓCaₓ)Fe_{1-y}Co_{y}O_{3-δ}, (Gd₁₋ₓSrₓ)Fe_{1-y}Co_{y}O_{3-δ}, (Gd₁₋ₓCaₓ)Fe_{1-y}Co_{y}O_{3-δ}, (Y,Ca)Fe_{1-y}Co_{y}O_{3-δ}, doped ceria, doped zirconia, or mixtures thereof and/or a metal oxide with an oxygen ion or proton conductivity. Ln=lanthanides. In the above formulae, x is preferably from about 0 to 1, more preferably from about 0.1 to 0.5, and most preferably from 0.2 to 0.3. Y is preferably from about 0 to 1, more preferably from about 0.1 to 0.5, and most preferably from 0.2 to 0.3.

The support layer can be any flexible or rigid layer capable of applying slurries. Examples of support layers can be, plastic, metals, glass, wood, ceramics, or polyethylene terephthalate films such as Mylar films.

After preparation of the anode slurry, electrolyte slurry and optional cathode slurry the first tape casting that occurs is an electrolyte slurry onto the support layer to produce an electrolyte layer situated above the support layer. In one embodiment no heat, vacuum, or pressure is involved in the application of this layer. The thickness of the electrolyte layer can be from about 1 μm to about 5 μm, from about 1 μm to about 10 μm, from about 1 μm to about 50 μm, from about 5 μm to about 10 μm or from about 5 μm to about 50 μm. It is envisioned that the electrolyte layer can comprise of a single electrolyte or multiple different electrolytes. If multiple different electrolytes are applied to the support layer each successive electrolyte slurry is tape casted to the subsequent slurry after the initial slurry has been tape casted to the support layer. In this embodiment, it is not envisioned that any heat, vacuum, or pressure is required in the application of these layers. In another embodiment, it is not envisioned that any vacuum or pressure is required in the application of these layers and heat would be used only as a catalyst to speed up the drying process.

After the application of the electrolyte layer the anode slurry is tape casted onto the electrolyte layer to produce a first multilayer structure comprising an anode layer situated above the electrolyte layer situated above the support layer. In one embodiment no heat, vacuum, or pressure is involved in the application of this layer. The thickness of the anode layer can be from about 100 m to about 1000 m or from about 200 m to about 500 μm. It is envisioned that the anode layer can comprise of a single electrolyte or multiple different anodes. If multiple different anodes are applied to the electrolyte layer each successive anode slurry is tape casted to the subsequent slurry after the initial slurry has been tape casted to the electrolyte layer. In this embodiment, it is not envisioned that any heat, vacuum, or pressure is required in the application of these layers. In another embodiment, it is not envisioned that any vacuum or pressure is required in the application of these layers and heat would be used only as a catalyst to speed up the drying process.

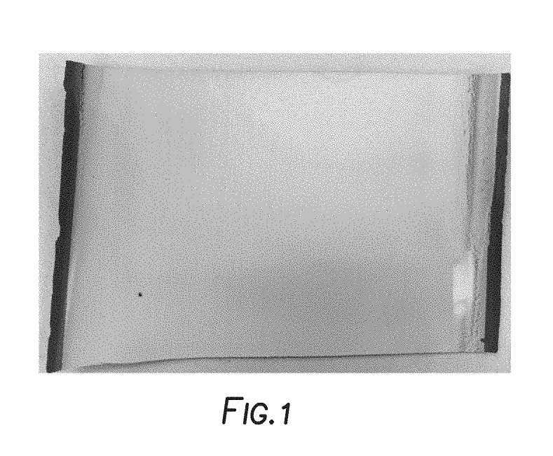

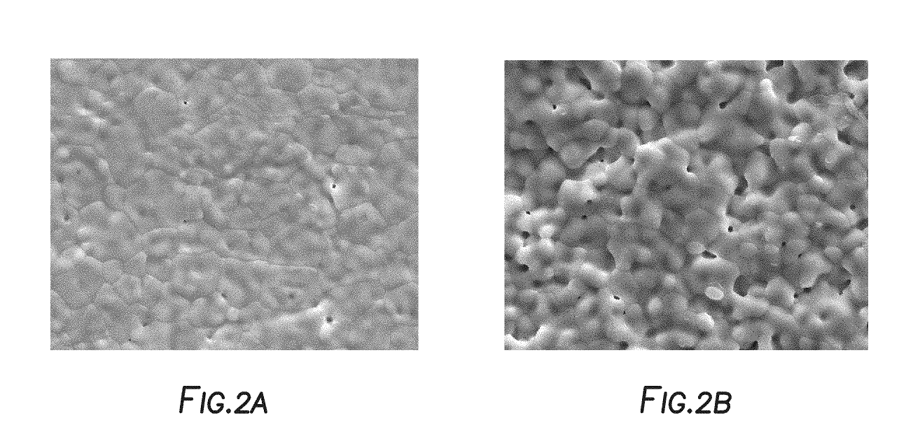

For speed of application each application of the anode or electrolyte layers can be applied wet and without waiting for the subsequent layer to dry. In other embodiments, the electrolyte layer is dried prior to applying the anode layer. After formation of the first multilayer structure the support layer is removed from the first multilayer structure to produce a second multilayer structure comprising the anode layer situated above the electrolyte layer. As shown in FIG. 1, the removal of the support layer does not demonstrate any visible cracks in the multilayer structure. Additionally, as shown in FIG. 2A, an electron microscope scan, at 2 μm, of the surface of the electrolyte layer reveals significantly less deformations of the electrolyte layers as compared to a typical spray coating technique FIG. 2B.

The second multilayer structure is then sintered to produce a solid oxide cell. The sintering step can be carried out at a temperature of from about 900° C. to about 1500° C., preferably from about 1000° C. to about 1400° C.

It is envisioned that during the formation of this solid oxide cell no lamination step, nor any vacuum, pressure or temperature is required to achieve bonding. As stated above and shown in FIG. 1 and FIG. 2, it is theorized that by eliminating these steps that are no visible cracks in the multilayer structure. Traditional lamination methods are unable to cast and handle thin layers such as 10 μm

Optionally a cathode layer can then be added to the solid oxide cell to produce a solid oxide fuel cell.

In other embodiments, the first layer applied to the support layer can be the anode layer and the corresponding layer applied on top of the anode layer can be the electrolyte layer.

In other embodiments after formation of the first multilayer structure successive layers of electrolyte layer and/or anode layer can be formed on the first multilayer structure.

The following examples of certain embodiments of the invention are given. Each example is provided by way of explanation of the invention, one of many embodiments of the invention, and the following examples should not be read to limit, or define, the scope of the invention.

### Example 1

Fabrication of yttria-stabilized zirconia (YSZ)/NiO-YSZ bi-layers: The cell fabrication process started with the preparation of YSZ electrolyte and NiO-YSZ anode slurries. The detailed compositions of the electrolyte and anode slurries can be found in Table I.

TABLE 1

| Category | Chemical | YSZ wt % | NiO—YSZ wt % |
|---|---|---|---|
| Ceramic | NiO | X | 38.5 |
| | YSZ | 52.7 | 25.7 |
| Dispersant | Fish oil | 1.5 | 1.7 |
| Solvents | Xylenes | 18.4 | 12.4 |
| | Ethyl alcohol | 18.4 | 12.4 |
| Plasticizers | Butyl benzyl phthalate | 2.3 | 1.8 |
| | Polyalkylene glycol | 2.6 | 3.1 |
| Binder | Polyvinyl butyral | 4.1 | 4.5 |

The ingredients were ball-milled for 48 hours to form stable and uniform slurries. The thin YSZ layer was fabricated first. Prior to casting, the homogenized slurry was de-gassed in a vacuum vessel at a gauge pressure of 64 cm mercury vacuum for 5 minutes under stirring condition to remove air bubbles. The ceramic slurry was then cast onto a film in a laboratory-scale tape caster using a fixed doctor blade gap of 40 μm. After the thin YSZ electrolyte layer was dried on the casting bed, the Ni-YSZ anode layer was cast over the YSZ electrolyte membrane using a 1250 μm gap. The resulting tape was dried on the casting bed overnight and then was cut into desired shape by using a programmable cutter or laser cutter. Sintering of the anode-electrolyte bilayer structure was carried out in a high-temperature furnace. Anode-electrolyte bilayer tapes were placed between a YSZ setter plate and a YSZ cover plate. Furnace temperature was raised at 2.0° C./min and the temperature was hold at 300 and 500° C. for 1 hour each to decompose and vent the organic components of the structure. Samples were finally sintered at 1400° C. for 5 hours to achieve full density. The gadolinium doped ceria (GDC) barrier layer slurry was prepared by mixing 10 wt % GDC powder with 1 wt % (polyvinyl butyral) PVB in isopropanol for 24 hours. The slurry was then applied to the sintered anode-electrolyte bilayer with a spray coater. After drying, the GDC layer was sintered at 1250° C. for 2 hours. The Sm_{0.5}Sr_{0.5}CoO₃ (SSC)-GDC cathode was also applied to the cells by using ultrasonic spray coating. The cathode was sintered in a box furnace at 950° C. for 2 hours.

### Example 2

Fabrication of YSZ/NiO-YSZ/NiO-PSZ cells: The cell fabrication process started with the preparation of YSZ electrolyte and NiO-YSZ anode functional layer (AFL), and NiO-partially stabilized zirconia (PSZ) anode slurries. The detailed compositions of the electrolyte and anode slurries can be found in Table II.

TABLE II

| | | YSZ | NiO—YSZ | NiO—PSZ |
|---|---|---|---|---|
| Category | Chemical | wt % | wt % | wt % |
| Ceramic | NiO | X | 30.4 | 34.9 |
| | YSZ | 53.2 | 23.9 | X |
| | PSZ | X | X | 23.2 |
| Dispersant | Fish oil | 1.5 | 1.5 | 1.6 |
| Solvents | Xylenes | 18.5 | 18.0 | 15.7 |
| | Ethyl alcohol | 18.5 | 18.0 | 15.7 |
| Plasticizers | Butyl benzyl | 1.5 | 1.5 | 1.6 |
| | phthalate | | | |
| | Polyalkylene glycol | 2.9 | 3.0 | 3.3 |
| Binder | Polyvinyl butyral | 3.9 | 3.7 | 4.0 |

The ingredients were ball-milled for 48 hours to form stable and uniform slurries. Prior to casting, the homogenized YSZ slurry was de-gassed in a vacuum vessel at a gauge pressure of −64 cm mercury vacuum for 5 min under stirring condition to remove air bubbles. The ceramic slurry was then cast onto a film in a laboratory-scale tape caster using a fixed doctor blade gap of 40 μm. After the thin YSZ electrolyte layer was dried on the casting bed, a Ni-YSZ AFL was cast on the YSZ electrolyte membrane with an 80 μm doctor blade gap. After dried in air for a few minutes, the Ni-PSZ anode support layer was cast on the top of Ni-YSZ AFL with a 1250 μm doctor blade gap. The resulting tri-layer tape was dried on the casting bed overnight and then was cut into desired by using a programmable cutter or a laser cutter. Sintering of the anode-electrolyte bilayer structure was carried out in a high-temperature furnace using a ramping rate of 2.0° C./min. The multi-layer structure was sintered at 1400° C. for 5 hours. The GDC barrier layer was applied to the sintered YSZ electrolyte surface by using ultrasonic spray coating method. After drying, the GDC layer was sintered at 1250° C. for 2 hours. A heating rate of 2.0° C./min was used during the sintering procedure. The SSC-GDC cathode was applied to the cells by using ultrasonic spray coating. SSC and GDC mixed at a weight ratio of 6:4 were used in the cathode slurry. The cathode was then dried in air and sintered in a box furnace at 950° C. for 2 hours.

### Example 3

Fabrication of YSZ/NiO-YSZ/NiO-PSZ-Ba cells: The cell fabrication process started with the preparation of YSZ electrolyte and NiO-YSZ AFL, and NiO-PSZ-Ba anode slurries. The detailed compositions of the electrolyte and anode slurries can be found in Table III.

TABLE III

| | | | NiO— | NiO— |
|---|---|---|---|---|
| | | YSZ | YSZ | PSZ—Ba |
| Category | Chemical | wt % | wt % | wt % |
| Ceramic | NiO | X | 38.5 | 37.4 |
| | YSZ | 59.4 | 25.6 | X |
| | PSZ | X | X | 25.0 |
| | BaCO₃ | X | X | 0.9 |
| Dispersant | Fish oil | 1.7 | 1.7 | 1.7 |
| Solvents | Xylenes | 14.7 | 12.4 | 12.9 |
| | Ethyl alcohol | 14.7 | 12.4 | 12.9 |
| Plasticizers | Butyl benzyl phthalate | 17 | 1.8 | 1.7 |
| | Polyalkylene glycol | 3.3 | 3.1 | 3.0 |
| Binder | Polyvinyl butyral | 4.5 | 4.5 | 4.3 |

The ingredients were ball-milled for 48 hours to form stable and uniform slurries. The thin YSZ layer was fabricated first. Prior to casting, the homogenized slurry was de-gassed in a vacuum vessel at a gauge pressure of 64 cm mercury vacuum for 5 min under mixing condition to remove air bubbles. The ceramic slurry was then cast onto a film in a laboratory-scale tape caster using a fixed doctor blade gap of 40 pin. After the thin YSZ electrolyte layer was dried on the casting bed, NiO-YSZ AFL were cast on the YSZ electrolyte membrane with an 80 pin gap doctor blade. After dried in air for few minutes, the Ni-PSZ-Ba anode supports were cast on the top of Ni-YSZ AFL with a 1250 μm gap doctor blade. The resulting tape was dried on the casting bed overnight and then was cut into desired by using a programmable cutter or a laser cutter. Sintering of the anode-electrolyte bilayer structure was carried out in a high-temperature furnace. The dry bilayer tapes were placed between a YSZ setter plate and a YSZ cover plate. A heating rate of 2.0° C./min was used with temperature holds for 1 hour at 300 and 500° C. to decompose and vent the organic components of the structure. Finally, the structure of YSZ/NiO-YSZ/NiO-PSZ-Ba were sintered at 1400° C. for 5 hours. The GDC barrier layer was applied to the sintered YSZ electrolyte surface by using ultrasonic screen printing. After drying, the GDC layer was sintered at 1250° C. for 2 hours. A heating rate of 2.0° C./min was used during the sintering procedure. The SSC-GDC cathode was applied to the cells by using ultrasonic spray coating. SSC and GDC mixed at a weight ratio of 6:4 were used in the cathode slurry. The cathode was then dried in air and sintered in a box furnace at 950° C. for 2 hours.

### Example 4

Fabrication of BaZr_{0.1}Ce_{0.7}Y_{0.1}Yb_{0.1}O₃ (BZCYYb)/NiO-BZCYYb cells: The cell fabrication process started with the preparation of BZCYYb electrolyte and NiO-BZCYYb anode slurries. The detailed compositions of the electrolyte and anode slurries can be found in Table IV.

TABLE IV

| | | BZCYYb | NiO—BZCYYb |
|---|---|---|---|
| Category | Chemical | wt % | wt % |
| Ceramic | NiO | X | 39.4 |
| | BZCYYb | 61.9 | 24.4 |
| Dispersant | Fish oil | 1.7 | 1.7 |
| Solvents | Xylenes | 13.6 | 12.6 |
| | Ethyl alcohol | 13.6 | 12.6 |
| Plasticizers | Butyl benzyl phthalate | 1.7 | 1.8 |
| | Polyalkylene glycol | 3.1 | 3.1 |
| Binder | Polyvinyl butyral | 4.5 | 4.4 |

The ingredients were ball-milled for 48 hours to form stable and uniform slurries. The thin BZCYYb layer was fabricated first. Prior to casting, the homogenized slurry was de-gassed in a vacuum vessel at a gauge pressure of 64 cm mercury vacuum for 5 min under mixing condition to remove air bubbles. The ceramic slurry was then cast onto a film in a laboratory-scale tape caster using a fixed doctor blade gap of 80 μm. After the thin BZCYYb electrolyte layer was dried on the casting bed, NiO-BZCYYb anode supports were cast on the BZCYYb electrolyte membrane with a 1250 μm gap. The resulting tape was dried on the casting bed overnight and then was cut into desired shape by using a programmable cutter or laser cutter or a punch. Sintering of the anode-electrolyte bilayer structure was carried out in a high-temperature furnace. The dry bilayer tapes were placed on a BZCYYb coated YSZ setter plate. A heating rate of 2.0° C./min was used with temperature holds for 1 hour at 300 and 500° C. to decompose and vent the organic components of the structure. Finally, the NiO-BZCYYb supported BZCYYb structures were sintered at 1400° C. for 5 hours. The LSCF-BZCYYb cathode was applied to the cells by using ultrasonic spray coating. LSCF and BZCYYb mixed at a weight ratio of 7:3 were used in the cathode slurry. The cathode was then dried in air and sintered in a box furnace at 1000° C. for 2 hours.

In closing, it should be noted that the discussion of any reference is not an admission that it is prior art to the present invention, especially any reference that may have a publication date after the priority date of this application. At the same time, each and every claim below is hereby incorporated into this detailed description or specification as an additional embodiment of the present invention.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

1. A process comprising the steps of:
separately preparing an anode slurry and an electrolyte slurry;
tape casting the electrolyte slurry onto a support layer to produce an electrolyte layer situated above the support layer;
tape casting the anode slurry onto the electrolyte layer to produce a first multilayer structure comprising an anode layer situated above the electrolyte layer situated above the support layer;
removing the support layer from the first multilayer structure to produce a second multilayer structure comprising the anode layer situated above the electrolyte layer; and
sintering the second multilayer structure to produce a solid oxide reactor.

2. The process of claim 1, wherein a lamination step is not performed.

3. The process of claim 1, wherein the formation of the solid oxide reactor occurs at ambient pressure.

4. The process of claim 1, wherein the removal of the support layer from the first multilayer structure produces a second multilayer structure without cracks.

5. The process of claim 1, wherein the electrolyte slurry comprises at least two different electrolyte slurries.

6. The process of claim 1, wherein a first anode slurry and a second anode slurry are prepared, wherein the first anode slurry and the second anode slurry are different, and are tape casted one on top of each another on the electrolyte slurry.

7. The process of claim 1, wherein the electrolyte slurry is an YSZ slurry.

8. The process of claim 1, wherein the anode slurry is a NiO-YSZ slurry.

9. The process of claim 1, wherein the support layer is a plastic film.

10. The process of claim 1, wherein the tape casting of the electrolyte layer ranges from about 1 μm to about 10 μm.

11. The process of claim 1, wherein the tape casting of the anode layer ranges from about 100 μm to about 1000 μm.

12. The process of claim 1, wherein the tape casting occurs at room temperature.

13. A process comprising the steps of:
separately preparing an anode slurry and an electrolyte slurry;
tape casting the electrolyte slurry onto a support layer to produce an electrolyte layer situated above the support layer;
tape casting the anode slurry onto the electrolyte layer to produce a first multilayer structure comprising an anode layer situated above the electrolyte layer situated above the support layer;
removing the support layer from the first multilayer structure to produce a second multilayer structure without cracks comprising the anode layer situated above the electrolyte layer; and
sintering the second multilayer structure to produce a solid oxide fuel cell without a lamination step.
